(19) United States
(12) Patent Application Publication
(10) Pub. No.: US 2026/0313231 A1
(43) Pub. Date: Oct. 8, 2026

(54) Learning-Based Camera Autofocus Prediction for Sparse Phase Detection Imaging Sensors

(71) Applicant: Google LLC, Mountain View, CA (US)

(72) Inventors: Stanley Wei Xian Chen, Mountain View, CA (US); Zihan Xu, San Jose, CA (US); Edward Chang, Mountain View, CA (US); Andrey Yatsunenko, Morgan Hill, CA (US); Katrina Hannover Passarella, Alameda, CA (US); Kumar Ayush, Mountain View, CA (US); Jwalant Bhatt, San Jose, CA (US); David Cong Tian, Foster City, CA (US); Joachim Jacques Lerman, Sunnyvale, CA (US); Desmond Akira Hollub Kamas, San Jose, CA (US); Hemang Mehta, Fremont, CA (US); Maria Lyubimtseva, Santa Clara, CA (US); Gerardo Carranza, Miami, FL (US); Vitalii Dziuba, Cupertino, CA (US)

(21) Appl. No.: 19/472,917

(22) PCT Filed: Jun. 23, 2023
(86) PCT No.: PCT/US2023/017752

§ 371 Date: Oct. 6, 2025

(51) Int. Cl. H04N 23/67; G03B 13/36; H04N 23/71; H04N 25/704

(52) U.S. Cl. CPC H04N 23/672; G03B 13/36; H04N 23/71; H04N 25/704

(57) ABSTRACT

A method includes receiving, from a plurality of sparse phase detection sensors, sparse phase detection sensor data. The method also includes determining a disparity prediction and an associated confidence value based on the sparse phase detection sensor data. The method further includes using the associated confidence value to determine an autofocus lens position for an image sensor based on the disparity prediction. The method additionally includes causing the image sensor to autofocus based on the determined autofocus lens position.

### BACKGROUND

Many modern computing devices, including mobile phones, personal computers, and tablets, include image capturing devices. Some image capturing devices are configured with telephoto capabilities.

### SUMMARY

In an embodiment, a method includes receiving, from a plurality of sparse phase detection sensors, sparse phase detection sensor data. The method also includes determining a disparity prediction and an associated confidence value based on the sparse phase detection sensor data. The method further includes using the associated confidence value to determine an autofocus lens position for an image sensor based on the disparity prediction. The method additionally includes causing the image sensor to autofocus based on the determined autofocus lens position.

In another embodiment, a system includes a processor and a non-transitory computer-readable medium having stored thereon instructions that, when executed by the processor, cause the processor to perform operations. The operations include receiving, from a plurality of sparse phase detection sensors, sparse phase detection sensor data. The operations also include determining a disparity prediction and an associated confidence value based on applying at least one machine learning model to the sparse phase detection sensor data. The operations further include using the associated confidence value to determine an autofocus lens position for an image sensor based on the disparity prediction, where using the associated confidence value to determine the autofocus lens position for the image sensor mitigates lens position fluctuations of the image sensor during autofocus caused by fluctuations within an image. The operations additionally include causing the image sensor to autofocus based on the determined autofocus lens position.

In a further embodiment, a computing device comprises a control system. The control system is configured to receive, from a plurality of sparse phase detection sensors, sparse phase detection sensor data. The control system is also configured to determine a disparity prediction and an associated confidence value based on the sparse phase detection sensor data. The control system is additionally configured to use the associated confidence value to determine an autofocus lens position for an image sensor based on the disparity prediction. The control system is further configured to cause the image sensor to autofocus based on the determined autofocus lens position.

In a further embodiment, a system is provided that includes means for receiving, from a plurality of sparse phase detection sensors, sparse phase detection sensor data. The system also includes means for determining a disparity prediction and an associated confidence value based on the sparse phase detection sensor data. The system further includes means for using the associated confidence value to determine an autofocus lens position for an image sensor based on the disparity prediction. The system additionally includes means for causing the image sensor to autofocus based on the determined autofocus lens position.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example computing device, in accordance with example embodiments.

FIG. 2 is a simplified block diagram showing some of the components of an example computing system.

FIG. 3 is a diagram illustrating a training phase and an inference phase of one or more trained machine learning models in accordance with example embodiments.

FIG. 4 depicts a sensor and a display, in accordance with example embodiments.

FIG. 5 depicts sparse phase detection sensor data, in accordance with example embodiments.

FIG. 6 is a block diagram representative of determining a disparity prediction and a confidence value, in accordance with example embodiments.

FIG. 7 is a block diagram of determining an autofocus lens position, in accordance with example embodiments.

FIG. 8 is a block diagram of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

A computing system may have and/or communicate with one or more sensors, such as cameras. These sensors may be able to capture images, which may be of various subjects, including people, the environment, scenery, among other examples. The sensors may focus on a particular object, a particular person, and/or the environment as a whole in the image. The particular object, the particular person, the environment, and/or other areas of interest may be varying distances away from the sensor, thereby requiring adjustments to the lens position with respect to the sensor such that the area of interest remains in focus. For example, in a first scene, a person may be half a meter away from the sensor, whereas in another scene, a group of people may be five meters away from the sensor. The lens position with respect to the sensor may be adjusted so that the focal point of the lens is half a meter away to capture the first scene and adjusted again so that the focal point of the lens is five meters away to capture the second scene.

In some examples, the computing system may use an autofocus process to determine an appropriate lens position such that the region of interest is in focus. In particular, the computing system may determine a region of interest at which to focus, and the computing system may determine an autofocus lens position such that the region of interest is in focus. Additionally and/or alternatively, the computing system may be provided a region of interest at which to focus, perhaps through receiving user input from a user interface on a device displaying the scene with the region of interest.

An issue may arise in this process where processing the sensor data for autofocus causes a delay due to the sensor data containing a significant amount of information, particularly in the case of high resolution sensor data. For example, for sensor data that includes 3840 by 2160 pixels and where a region of interest may include one or more pixels of the sensor data, the computing system may have difficulty focusing accurately and quickly due to the amount of sensor data used in determining the autofocus lens position. Further, low resolution sensor data may be collected by lower cost sensors, while the value provided by the sensors may be higher or roughly amount to the value provided by the high resolution sensors.

Provided herein are methods for determining an autofocus lens position using low resolution sensor data, which may facilitate quicker and more accurate determinations of autofocus lens position. In particular, the computing system may apply a machine learning model to low resolution sensor data (e.g., sparse phase detection sensor data) to determine the autofocus lens position relative to an image sensor. The machine learning model may learn from context, which may enable the use of sensor data that includes less information, while still providing an accurate determination of autofocus lens position.

A computing device may determine the autofocus lens position for an image sensor on the computing device (e.g., an image sensor on a mobile device). Additionally and/or alternatively, the computing device may determine the autofocus lens position for an image sensor separate from the computing device (e.g., a laptop may determine the autofocus lens position for a digital camera separate from the laptop). As described herein, a computing system may refer to a computing device connected to an image sensor or other sensors such that the computing device may send signals to the sensor(s) wirelessly or through wired communication, and such that the sensor(s) may send signals wirelessly or through wired communications to the computing device. Additional components may also be included in the computing system.

In some examples, the computing system may further include sparse phase detection sensors. The sparse phase detection sensors may be separate from or included in the image sensors. The computing system may use the sparse phase detection sensors to collect sparse phase detection sensor data, which may be low resolution sensor data, particularly in comparison to other phase detection sensor data (e.g., dense phase detection sensor data). The computing system may receive sparse phase detection sensor data from one or more sparse phase detection sensors. In some examples, each pixel in the sparse phase detection sensor data may include left and right sparse phase detection sensor data.

The computing system may input the sparse phase detection sensor data into a machine learning model to determine a disparity prediction and an associated confidence value. The machine learning model may include two sub-models, such that a representation of the sparse phase detection sensor data is input into both sub-models. One of the sub-models may output a disparity prediction. The other sub-model may take this disparity prediction (in addition to a representation of the sparse phase detection sensor data) to determine a confidence value of the disparity prediction. In some examples, the architecture of the sub-model used for the disparity prediction may be or resemble a MobileNet architecture.

Based on the determined disparity prediction and associated confidence value, the computing system may determine an autofocus lens position. In particular, the computing system may first filter the determined disparity prediction, perhaps based on the confidence value and other factors. Based on the filtered prediction, the computing system may determine the autofocus lens position. In some examples, the autofocus lens position may also be based on a defocus conversion coefficient and an offset factor to correct for the difference between phase detection prediction and an established contrast-based focus. In some examples, the established contrast-based focus may be predefined and a well established contrast-based best focus.

In some examples, the computing system may determine whether the confidence value is above a threshold confidence value. If the computing system determines that the confidence value is above the threshold confidence value, the computing system may proceed with determining the autofocus lens position based on the disparity prediction. If the confidence value is not above threshold confidence value, the computing system may determine the autofocus lens position based on a previous disparity prediction, perhaps through filtering one or more previous disparity predictions with the current disparity prediction. Filtering the one or more previous disparity predictions with the current disparity prediction may facilitate smoother autofocus, as the lens position may be able to stay in the same position until the disparity prediction is more confident. More confident disparity predictions may indicate that the sensor(s) may have stopped moving, that the subject in the scene has stopped moving, and/or that the lighting of the scene is sufficient, among other examples. Additionally and/or alternatively, the computing system may determine the autofocus lens position based on other detection methods, such as laser sensors, contrast-based sensors, stereo sensors, and/or time of flight sensors.

In further examples, the computing system may directly detect factors that may contribute to uncertainty in the determined lens position, in addition to or rather than relying on the determined confidence value. In particular, the computing system may detect that the disparity prediction is a high disparity prediction and the computing system may then determine a filtered disparity prediction based on one or more previous disparity predictions and the current disparity prediction. Additionally and/or alternatively, the computing system may determine a scene lighting change. Based on determining that the lighting change is a high lighting change (e.g., the lighting change from left sparse phase detection sensor data to right sparse phase detection sensor data), the computing system may determine a filtered disparity prediction based on one or more previous disparity predictions and the current disparity prediction. Otherwise, the computing system may use the determined disparity prediction for the current scene.

In applying a filter to the disparity predictions, the computing system may make a selection between one or more filters. In particular, the computing system may make a determination of whether to apply a recursive finite impulse response Kolmogorov-Zurbenko filter, a recursive exponential infinite impulse response filter, or to return the current disparity prediction. This decision may be based on a variety of factors, including the disparity prediction, the associated confidence value, the lighting, among other factors.

By determining whether to apply a filter and determining which filter to apply, the computing system may facilitate smooth lens movement during autofocus while also minimizing any autofocus delay caused by applying the filter. In particular, in situations where the computing system is confident in the disparity prediction (whether that confidence is determined through the associated confidence value or other factors such as lighting and scene change), the computing system may select to use the disparity prediction without filtering to determine an autofocus lens position, rather than causing a delay by applying a filter. Whereas, if the disparity prediction is more uncertain, the computing system may apply a filter to smooth lens movement despite the potential autofocus delay that the filter may cause. In applying the filter to smooth lens movement in situations where the disparity predictions are less certain, the computing system may improve user experience while causing a negligible effect on the quality and speed of the autofocus.

Based on the determined disparity prediction, the computing system may determine the lens position, perhaps through a mapping of the disparity prediction to lens movement. Specifically, a computing system may apply a defocus conversion coefficient and an offset factor to correct for the difference between a phase detection prediction and an established contrast-based focus. In some examples, the computing system may apply one or more defocus conversion coefficients, such that each defocus conversion coefficient is associated with a region in the image. After having determined the lens prediction, the computing system may cause an image sensor to focus by causing the image sensor to move based on the determined lens position.

### II. Example Systems and Methods

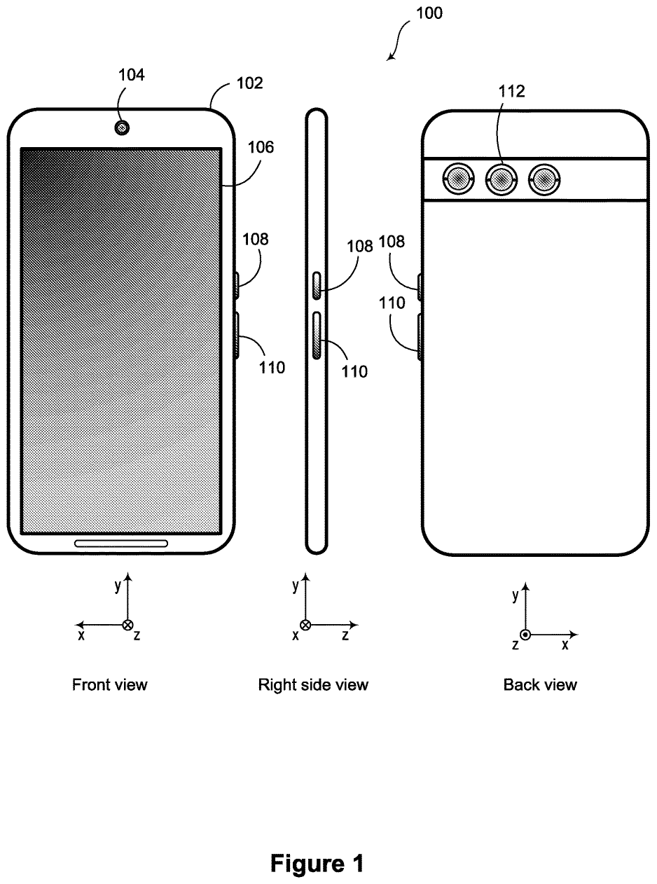

FIG. 1 illustrates an example computing device 100. In examples described herein, computing device 100 may be an image capturing device and/or a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

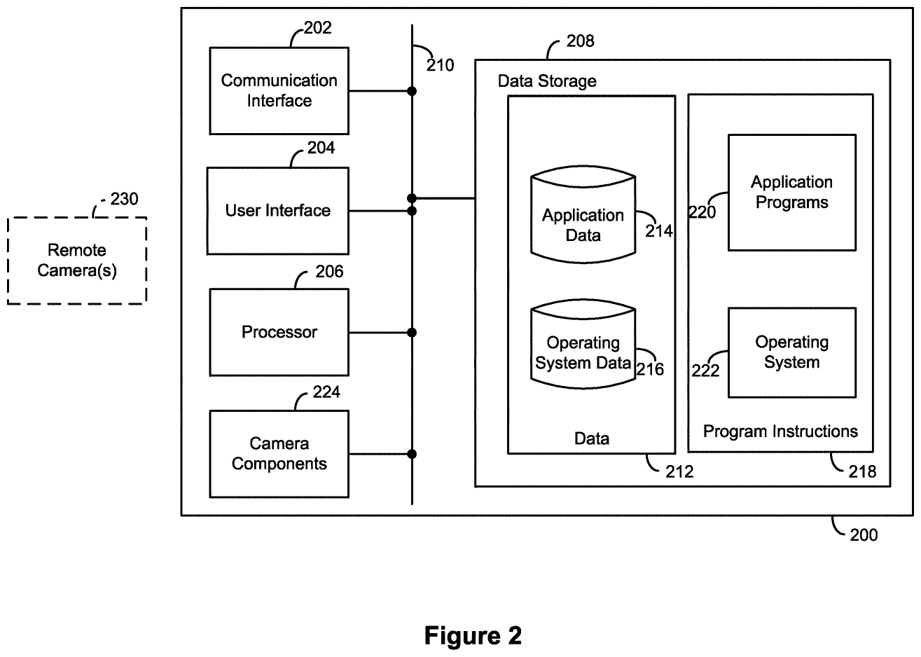

FIG. 2 is a simplified block diagram showing some of the components of an example computing system 200, such as an image capturing device and/or a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

In further examples, one or more remote cameras 230 may be controlled by computing system 200. For instance, computing system 200 may transmit control signals to the one or more remote cameras 230 through a wireless or wired connection. Such signals may be transmitted as part of an ambient computing environment. In such examples, inputs received at the computing system 200 (for instance, physical movements of a wearable device) may be mapped to movements or other functions of the one or more remote cameras 230. Images captured by the one or more remote cameras 230 may be transmitted to the computing system 200 for further processing. Such images may be treated as images captured by cameras physically located on the computing system 200.

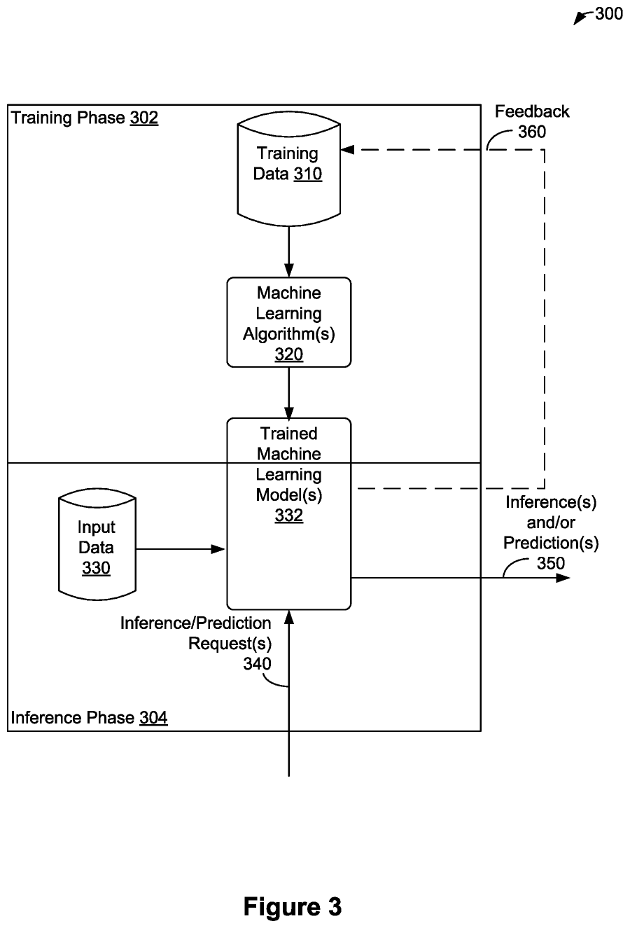

FIG. 3 shows diagram 300 illustrating a training phase 302 and an inference phase 304 of trained machine learning model(s) 332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model 332. Producing trained machine learning model(s) 332 during training phase 302 may involve determining one or more hyperparameters, such as one or more stride values for one or more layers of a machine learning model as described herein. Then, during inference phase 304, trained machine learning model 332 can receive input data 330 and one or more inference/prediction requests 340 (perhaps as part of input data 330) and responsively provide as an output one or more inferences and/or predictions 350. The one or more inferences and/or predictions 350 may be based in part on one or more learned hyperparameters, such as one or more learned stride values for one or more layers of a machine learning model as described herein

As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results.

Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310. This further training of the machine learning algorithm(s) 320 and/or the pre-trained machine learning model using training data 310 of CD1's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

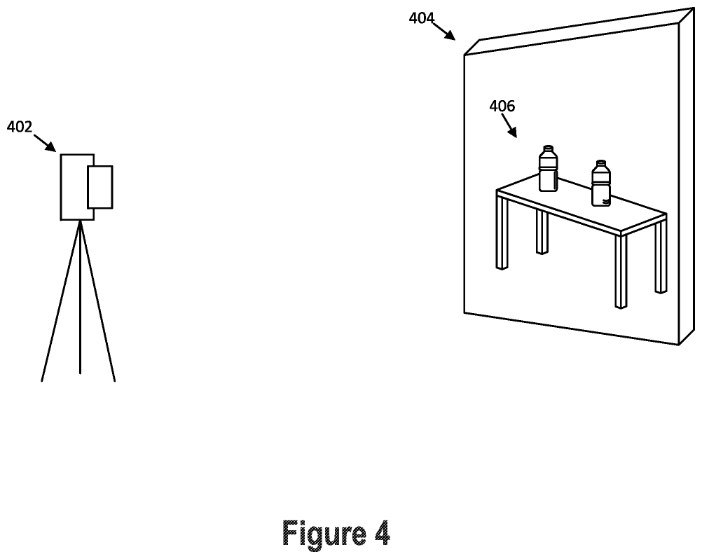

FIG. 4 depicts sensor 402 and display 404, in accordance with example embodiments. Sensor 402 may be configured to take an image or otherwise collect data of display 404, which may be displaying image 406. This configuration of sensor 402 collecting data from display 404 may help facilitate determining a dataset for training the machine learning model mentioned above. The dataset may include sensor data and associated labels.

In particular, display 404 may be a high-resolution display, and sensor 402 may be a sensor capable of capturing sparse phase detection sensor data. Sensor 402 may capture sparse phase detection sensor data of image 406 as presented by display 404. Because display 404 may present image 406 in high resolution, the sparse phase detection sensor data captured by sensor 406 may roughly amount to sparse phase detection sensor data taken of the scene in image 406. In particular, the sparse phase detection sensor data collected of image 406 displayed on display 404 may include information indicative of depth, such that the computing system may be able to determine a focus point based on the collected sparse phase detection sensor data.

Based on the sparse phase detection sensor data, the computing system may determine one or more labels. Each label may be of a disparity prediction from which an autofocus lens position may be determined. In some examples, a pair of sparse phase detection sensor data such that each sparse phase detection sensor data is collected of the same scene at two different fields of view (e.g., a right view and a left view) may be associated with a disparity prediction.

The computing system may determine a disparity label from one or more images captured of image 406 displayed on display 404. In particular, the computing system may determine a disparity label for the captured image(s) using a block matching proxy algorithm or a contrast autofocus algorithm. The computing system may capture focus sweeps of sensor data at various focus positions (e.g., macro focus to infinity focus), and the computing system may determine and plot how focused each image is, resulting in a plot with the maximum associated with the most focused sensor data and focus position. The disparity label may be determined based on the focus sweeps of the sensor data at these various focus positions. In some examples, the computing system may determine the labels based on the block matching proxy algorithm when the machine learning model has not been trained, and otherwise, the computing system may determine the labels based on the trained machine learning model.

To help increase the accuracy of the machine learning model, the computing system may also apply a list of augmentations to the training dataset. In some examples, the computing system may crop the determined sparse phase detection sensor data to remove one or more pixels along the length of the sparse phase detection sensor data and/or one or more pixels along the width of the sparse phase detection sensor data. Such an augmentation may help simulate hand jitter, and a machine learning model trained using a dataset with such an augmentation may be more accurate in determining autofocus lens position even when the user's hand is jittering. Other augmentations are also possible.

The computing system may use the training data to train a machine learning model that may be used to determine a disparity prediction, which may then be used to determine an autofocus lens position. In some examples, the computing system may store the trained machine learning model. Additionally and/or alternatively, the computing system may send the trained machine learning model to another computing system for use. The computing system that runs the model may be wirelessly connected to or physically connected to one or more sensors, including one or more sparse phase detection sensors and/or one or more image sensors.

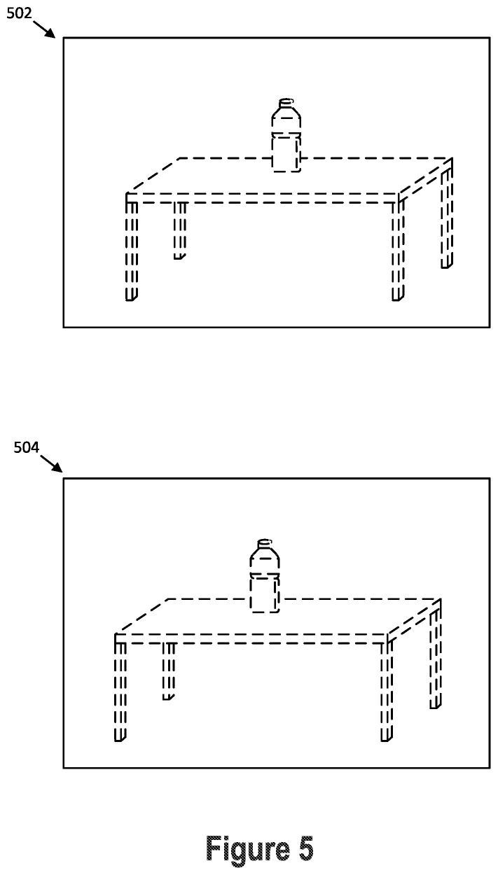

FIG. 5 depicts sparse phase detection sensor data, in accordance with example embodiments. As mentioned above, each pixel in the sparse phase detection sensor data may include associated left sparse phase detection sensor data and associated right sparse phase detection sensor data. For the sparse phase detection sensor data that is collected, left sparse phase detection sensor data may be illustrated here as sparse phase detection sensor data 502 and the right sparse phase detection sensor data may be illustrated here as sparse phase detection sensor data 504. The computing system may receive sparse phase detection sensor data 502 and sparse phase detection sensor data 504 from one or more sparse phase detection sensors.

As mentioned above, sparse phase detection sensor data 502 and 504 may be low resolution sensor data. Using low resolution sensor data such as sparse phase detection sensor data 502 and 504 may enable the computing system to determine an autofocus lens position more quickly, thereby improving user experience. Low resolution sensor data may include less data, thereby resulting in the computing system running less calculations when compared to a process that uses higher resolution sensor data (e.g., dense phase detection sensor data).

The computing system may also use other types of sensor data as an alternative or in addition to sparse phase detection sensor data 502 and 504. For instance, the computing system may capture images from an image sensor. These images may be low resolution and/or the computing system may filter the images to be low resolution. These images may then be used to predict an autofocus lens position.

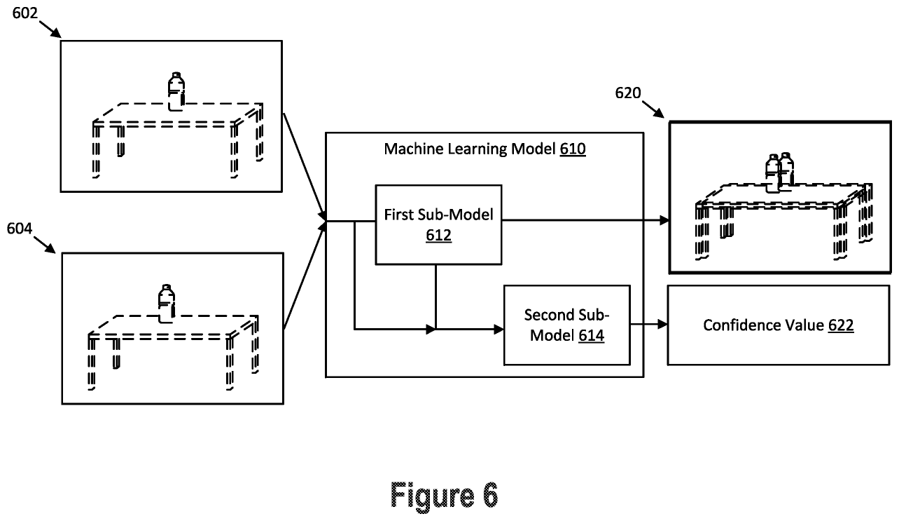

FIG. 6 is a block diagram representative of determining a disparity prediction and a confidence value, in accordance with example embodiments. As mentioned above, sensor data, e.g., sparse phase detection sensor data 602 and sparse phase detection sensor data 604, may be input into machine learning model 610 to determine a disparity prediction and an associated confidence value, e.g., disparity prediction 620 and confidence value 622.

Machine learning model 610 may include one or more machine learning models, including, for example, first sub-model 612 and second sub-model 614. First sub-model 612 may take sparse phase detection sensor data 602 and sparse phase detection sensor data 604 as an input and may output disparity prediction 620. In some examples, the architecture of the first sub-model may be or resemble a MobileNet architecture. Second sub-model 614 may take sparse phase detection sensor data 602 and 604 as well as disparity prediction 620 and output confidence value 622. Specifically, second sub-model 614 may include one or more layers that take a representation of sparse phase detection sensor data 602 and 604 as an input and one or more additional layers that take a representation of disparity prediction 620 as an input. Second sub-model 614 may further include one or more further layers, which may take the output of the one or more labels and the one or more additional layers as an input and output a confidence measure associated with the disparity prediction.

In some examples, the machine learning model may include additional layers and/or machine learning models outside of first sub-model 612 and second sub-model 614. For example, the machine learning model may include a normalization layer for sparse phase detection sensor data 602 and 604, and first sub-model 612 and second sub-model 614 may take the normalized representation of sparse phase detection sensor data 602 and 604 as an input rather than sparse phase detection sensor data 602 and 604.

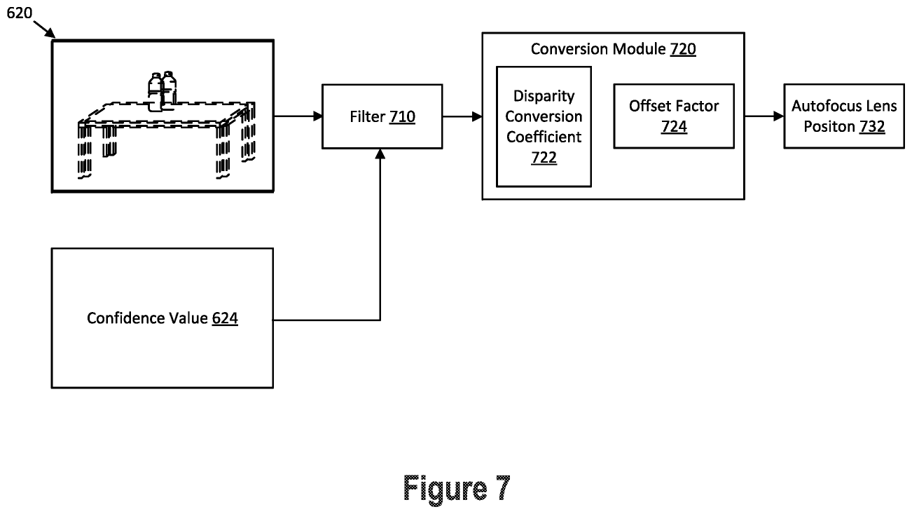

FIG. 7 is a block diagram representative of determining autofocus lens position 732, in accordance with example embodiments. In some examples, the computing system may apply filter 710 and conversion module 720 based on disparity prediction 620 and confidence value 624 to determine autofocus lens position 732. The computing system may apply filter 710 to disparity prediction 620 based on confidence value 624, and then computing system may apply conversion module 720 to the filtered disparity prediction to determine autofocus lens position 732.

Applying filter 710 to disparity prediction 620 based on confidence value 624 may help facilitate smooth lens movement such that the autofocus lens position does not unnecessarily fluctuate when the autofocus is applied to an image data or a stream of image data The computing system may retrieve one or more previous disparity predictions and/or autofocus lens positions at filter 710. Applying filter 710 may involve selecting between applying a recursive finite impulse response Kolmogorov-Zurbenko filter to disparity prediction 620 and/or one or more of the previous disparity predictions, applying a recursive exponential infinite impulse response filter to disparity prediction 620 and/or one or more of the previous disparity predictions, or purging the filter and buffers of the one or more previous disparity predictions and returning disparity prediction 620.

To select between applying a recursive finite impulse response Kolmogorov-Zurbenko filter, applying a recursive exponential infinite impulse response filter, or returning disparity prediction 620, the computing system may determine one or more factors that may impact the accuracy of the autofocus lens position. For example, the computing system may determine to return a previous disparity prediction or to filter disparity prediction 620 when the confidence value is low, perhaps so that the autofocus lens position does not continuously fluctuate when the autofocus lens position error is uncertain. Additionally and/or alternatively, the computing system may determine a change in lighting between sparse phase detection sensor data 602 and 604, and based on the change in lighting between sparse phase detection sensor data 602 and 604, the computing system may determine whether the to apply one of the filters or return disparity prediction 620. Further additionally and/or alternatively, the computing system may determine a change in phase detection disparity between sparse phase detection sensor data 602 and 604 and/or previous sparse phase detection sensor data, and the computing system may use this change to determine whether to apply one of the filters or return disparity prediction 620.

The computing system may apply one of the filters when one of the factors indicates that the disparity prediction is uncertain. For example, the computing system may apply a filter when confidence value 624 is low, when the computing system detects a large change in disparity predictions (e.g., from near focus to wide focus or vice versa), and/or when the computing system detects a large change in lighting conditions, among other factors. In contrast, when confidence value 624 is high, when the computing system does not detect a large change in disparity predictions, and/or when the computing system does not detect a large change in lighting conditions, among other factors, the computing system may apply disparity prediction 620, as the disparity prediction and associated autofocus lens position may be unlikely to fluctuate.

Based on the filtered disparity prediction, the computing system may apply conversion module 720, which may convert the filtered disparity prediction into autofocus lens position 732. In some examples, determining autofocus lens position 732 may be based on defocus conversion coefficient 722 and offset factor 724. Defocus conversion coefficient 722 may include one or more defocus conversion coefficients, each of which may be associated with a region in a field of view of the image sensor. Specifically, the field of view of the image sensor may be segmented into a plurality of regions (e.g., a grid of tiles), and each region (or tile) in the filtered disparity prediction may be associated with a pre-determined defocus conversion coefficient of defocus conversion coefficient 722. Each defocus conversion coefficient may be a pre-determined function that maps the disparity prediction to lens movement. In some examples, the defocus conversion coefficient may be based on the lens position before causing the image lens to position based on the disparity prediction.

After having determined autofocus lens position 732, the computing system may cause an image sensor to position itself based on the autofocus lens position 732. Positioning the image sensor based on the autofocus lens position may cause the image sensor to focus on one or more subjects in the image.

The operations described herein may be executed using a control system, which may include a central processing unit and/or a tensor processing unit. In some examples, the tensor processing unit may execute processes that are parallelizable. For instance, the tensor processing unit may determine the disparity prediction and the associated confidence value based on applying the machine learning model to the sparse phase detection sensor data. In contrast, the central processing unit may be configured to receive the sparse phase detection sensor data, execute one or more pre-processing processes of the sparse phase detection sensor data before the sparse phase detection sensor data is input into the machine learning model, determine the autofocus lens position, and/or execute one or more post-processing processes of the machine learning model output. The tensor processing unit and the central processing unit may be connected, such that the central processing unit may send information to and receive information from the tensor processing unit and that the tensor processing unit may send information to and receive information from the central processing unit.

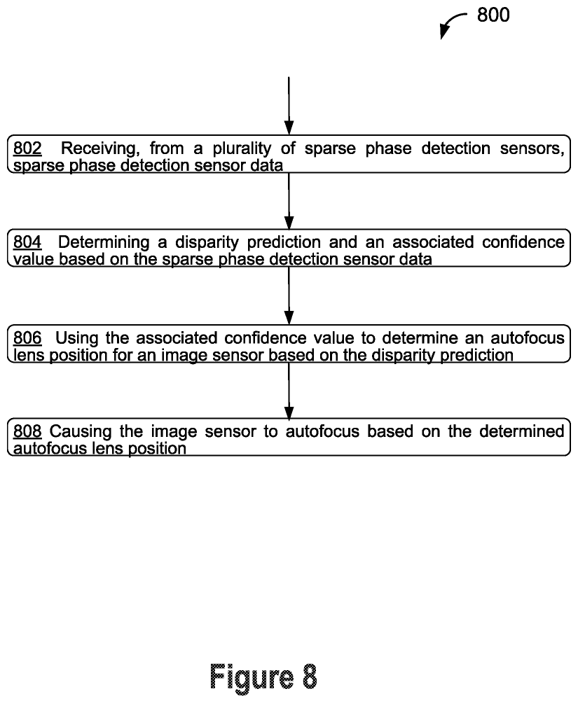

FIG. 8 is a block diagram of method 800, in accordance with example embodiments. Blocks 802, 804, 806, and 808 may collectively be referred to as method 8. In some examples, method 800 may be executed by one or more computing systems (e.g., computing system 200 of FIG. 2) and/or one or more processors (e.g., processor 206 of FIG. 2). In further examples, method 800 may be carried out on a computing device, such as computing device 100 of FIG. 1. Execution of method 800 may involve a computing device or server device remote from computing device 100. Other computing devices may also be used in the performance of method 800. The one or more computing devices and/or one or more computing systems used in the execution of method 800 may be collectively referred to herein as a “computing system.”

At block 802, method 800 includes receiving, from a plurality of sparse phase detection sensors, sparse phase detection sensor data.

At block 804, method 800 includes determining a disparity prediction and an associated confidence value based on the sparse phase detection sensor data.

At block 806, method 800 includes using the associated confidence value to determine an autofocus lens position for an image sensor based on the disparity prediction.

At block 808, method 800 includes causing the image sensor to autofocus based on the determined autofocus lens position.

In some examples, using the associated confidence value to determine the autofocus lens position for the image sensor mitigates lens position fluctuations of the image sensor during autofocus caused by fluctuations within an image.

In some examples, the sparse phase detection sensor data is low resolution sensor data.

In some examples, determining the disparity prediction and the associated confidence value is based on applying at least one machine learning model to the sparse phase detection sensor data.

In some examples, the machine learning model is trained using a dataset comprising a plurality of sparse phase detection sensor data captured from images displayed on a high resolution display.

In some examples, the machine learning model is trained using a dataset comprising one or more images and one or more associated labels, where the dataset is processed using a list of augmentations such that the list of augmentations causes additional images and labels to be generated.

In some examples, the list of augmentations comprises an augmentation associated with cropping the one or more images and determining labels for the one or more cropped images to simulate hand jitter.

In some examples, the machine learning model is trained using a dataset comprising one or more images and one or more labels, where each image of the one or more images is processed using a contrast autofocus algorithm and a defocus conversion coefficient to generate the associated label.

In some examples, the defocus conversion coefficient is determined based on a pre-trained machine learning model.

In some examples, the defocus conversion coefficient is determined based on a block matching proxy algorithm.

In some examples, the machine learning model comprises a first sub-model and a second sub-model, wherein a representation of the sparse phase detection sensor data is input into the first sub-model to generate the disparity prediction, wherein the representation of the sparse phase detection sensor data and the disparity prediction is input into the second sub-model to generate the associated confidence value.

In some examples, the first sub-model is based on a MobileNet architecture.

In some examples, using the associated confidence value to determine the autofocus lens position for the image sensor based on the disparity prediction comprises receiving one or more defocus conversion coefficients, wherein each of the one or more defocus conversion coefficients are associated with a region of the sparse phase detection sensor data. Using the associated confidence value to determine the autofocus lens position for the image sensor based on the disparity prediction may further comprise determining, based on the one or more defocus conversion coefficients, the autofocus lens position. Using the associated confidence value to determine the autofocus lens position for the image sensor based on the disparity prediction may also comprise verifying the autofocus lens position based on the associated confidence value.

In some examples, the associated confidence value to determine the autofocus lens position is further based on an offset factor.

In some examples, using the associated confidence value to determine the autofocus lens position for the image sensor is further based on a lighting level disparity.

In some examples, the disparity prediction is a high disparity prediction, wherein using the associated confidence value to determine the autofocus lens position for the image sensor is further based on the high disparity prediction such that the high disparity prediction causes the autofocus lens position to be further based on a previous autofocus lens position.

In some examples, using the associated confidence value to determine the autofocus lens position for the image sensor based on the disparity prediction comprises verifying whether the associated confidence value is above a threshold confidence value. Using the associated confidence value to determine the autofocus lens position for the image sensor further comprises, based on verifying that the associated confidence value is above the threshold confidence value, determining the autofocus lens position to be associated with the disparity prediction rather than a previous disparity prediction.

In some examples, a computing system comprises a control system, and the control system may be configured to execute the blocks of method 800.

In some examples, the control system comprises a tensor processing unit, wherein the tensor processing unit is configured to determine the disparity prediction and the associated confidence value based on applying the at least one machine learning model to the sparse phase detection sensor data.

In some examples, the control system comprises a central processing unit, wherein the central processing unit is configured to receive the sparse phase detection sensor data, use the associated confidence value to determine the autofocus lens position, and cause the image sensor to autofocus based on the determined autofocus lens position.

In some examples, using the associated confidence value to determine the autofocus lens position for the image sensor based on the disparity prediction comprises verifying whether the associated confidence value is above a threshold confidence value. Using the associated confidence value to determine the autofocus lens position or the image sensor may also comprise, based on verifying that the associated confidence value is above the threshold confidence value, determining the autofocus lens position to be associated with the disparity prediction rather than a previous disparity prediction.

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method comprising:
receiving, from a plurality of sparse phase detection sensors, sparse phase detection sensor data;
determining a disparity prediction and an associated confidence value;
using the associated confidence value to determine an autofocus lens position for an image sensor based on the disparity prediction; and
causing the image sensor to autofocus based on the determined autofocus lens position.

2. The method of claim 1, wherein using the associated confidence value to determine the autofocus lens position for the image sensor mitigates lens position fluctuations of the image sensor during autofocus caused by fluctuations within an image.

3. The method of claim 1, wherein the sparse phase detection sensor data is low resolution sensor data.

4. The method of claim 1, wherein the determining the disparity prediction and the associated confidence value is based on applying at least one machine learning model to the sparse phase detection sensor data.

5. The method of claim 4, wherein the machine learning model is trained using a dataset comprising a plurality of sparse phase detection sensor data captured from images displayed on a high resolution display.

6. The method of claim 4, wherein the machine learning model is trained using a dataset comprising one or more images and one or more associated labels, wherein the dataset is processed using a list of augmentations such that the list of augmentations causes additional images and labels to be generated.

7. The method of claim 6, wherein the list of augmentations comprises an augmentation associated with cropping the one or more images and determining labels for the one or more cropped images to simulate hand jitter.

8. The method of claim 4, wherein the machine learning model is trained using a dataset comprising one or more images and one or more labels, wherein each image of the one or more images is processed using a contrast autofocus algorithm and a defocus conversion coefficient to generate the associated label.

9. The method of claim 8, wherein the defocus conversion coefficient is determined based on a pre-trained machine learning model.

10. The method of claim 8, wherein the defocus conversion coefficient is determined based on a block matching proxy algorithm.

11. The method of claim 3, wherein the machine learning model comprises a first sub-model and a second sub-model, wherein a representation of the sparse phase detection sensor data is input into the first sub-model to generate the disparity prediction, wherein the representation of the sparse phase detection sensor data and the disparity prediction is input into the second sub-model to generate the associated confidence value.

12. The method of claim 11, wherein the first sub-model is based on a MobileNet architecture.

13. The method of claim 1, wherein using the associated confidence value to determine the autofocus lens position for the image sensor based on the disparity prediction comprises:
receiving one or more defocus conversion coefficients, wherein each of the one or more defocus conversion coefficients are associated with a region of the sparse phase detection sensor data;
determining, based on the one or more defocus conversion coefficients, the autofocus lens position; and
verifying the autofocus lens position based on the associated confidence value.

14. The method of claim 1, wherein using the associated confidence value to determine the autofocus lens position is further based on an offset factor.

15. The method of claim 1, wherein using the associated confidence value to determine the autofocus lens position for the image sensor is further based on a lighting level disparity.

16. The method of claim 1, wherein the disparity prediction is a high disparity prediction, wherein using the associated confidence value to determine the autofocus lens position for the image sensor is further based on the high disparity prediction such that the high disparity prediction causes the autofocus lens position to be further based on a previous autofocus lens position.

17. The method of claim 1, wherein using the associated confidence value to determine the autofocus lens position for the image sensor based on the disparity prediction comprises:
verifying whether the associated confidence value is above a threshold confidence value;
based on verifying that the associated confidence value is above the threshold confidence value, determining the autofocus lens position to be associated with the disparity prediction rather than a previous disparity prediction.

18. A computing system comprising:
a control system configured to:
receive, from a plurality of sparse phase detection sensors, sparse phase detection sensor data;
determine a disparity prediction and an associated confidence value based on the sparse phase detection sensor data;
use the associated confidence value to determine an autofocus lens position for an image sensor based on the disparity prediction; and
cause the image sensor to autofocus based on the determined autofocus lens position.

19. The computing system of claim 16, wherein the control system comprises a tensor processing unit, wherein the tensor processing unit is configured to determine the disparity prediction and the associated confidence value based on applying at least one machine learning model to the sparse phase detection sensor data.

20. A non-transitory computer readable medium storing program instructions executable by one or more processors to cause the one or more processors to perform operations comprising:
receiving, from a plurality of sparse phase detection sensors, sparse phase detection sensor data;
determining a disparity prediction and an associated confidence value based on the sparse phase detection sensor data;
using the associated confidence value to determine an autofocus lens position for an image sensor based on the disparity prediction; and
causing the image sensor to autofocus based on the determined autofocus lens position.
